(19) United States
(12) Patent Application Publication
(10) Pub. No.: US 2007/0168876 A1
(43) Pub. Date: Jul. 19, 2007

(54) Method and system for selecting objects

(76) Inventors: Susann Marie Keohane, Austin, TX (US); Gerald Francis McBrearty, Austin, TX (US); Shawn Patrick Mullen, Buda, TX (US); Jessica Murillo, Round Rock, TX (US); Johnny Meng-Han Shieh, Austin, TX (US)

Correspondence Address: Richard A. Henkler, 117 Old Stage Road, Essex, VT, 05452, US

(21) Appl. No.: 11/334,701

(22) Filed: Jan. 18, 2006

(51) Int. Cl. G06F 9/00; G06F 3/00

(52) U.S. Cl. 715/764; 715/862; 715/835; 715/856

(57) ABSTRACT

A method, system, and computer program product for selecting an object from nested group of objects. Upon the determination of an incorrect selection, the selection of an object that is different from the current selected object is accomplished using a predetermined path.

### BACKGROUND

1. Technical Field of the Present Invention

The present invention generally relates to application software, and more specifically, to methods, systems, and computer program products that assist a user in selecting an object nested with other objects.

2. Description of Related Art

The use and dependency upon computers for increased productivity and instantaneous access to information has increased exponentially over the past few years. As a result, computers have almost become inseparable from our everyday lives.

One particular field that has benefited from the use of computers is automated drawing application software. The various types of automated drawing application software can range from traditional Computer Aided Design (CAD) to less sophisticated drawing programs.

The average user of this type of software will, inevitably, encounter the situation where they intend to select an object that is nested with other objects. The user attempts to select an intended object from among the other objects by moving a cursor (e.g. arrow) over what appears to be the selected object and executing a particular action to indicate their selection (e.g. clicking the mouse). As a result of the objects being closely nestled one to another, the drawing application will often select the wrong object. In response, the user will attempt to again move the cursor to what they consider to be the desired object and repeat the selection process again. The frustration of selecting and re-selecting continues until the desired object is finally selected. More sophisticated users will attempt to increase the magnification level of the drawing until they believe the desired object is clearly distinguishable from the other nested objects, perform the selection, and then return to the previous desired magnification level. This process of constantly changing the magnification level is both tedious and visually strenuous.

It would, therefore, be a distinct advantage if the user were able to move the cursor (or other indicator) over an object that is nested among other objects and select the desired object without the tedious actions previously described.

### SUMMARY OF THE PRESENT INVENTION

In one aspect, the present invention is a computer implemented method of selecting an object. The method includes the step of, in response to receiving a selection signal from a selection means indicating a selection position in close proximity to a plurality of objects, indicating a selection of a first one of the plurality of objects. The method also includes the step of, in response to subsequently receiving a subsequent selection signal from the selection means having the same selection position, indicating a selection of a different one of the plurality of objects.

### BRIEF DESCRIPTION OF THE DRAWINGS

The present invention will be better understood and its numerous advantages will become more apparent to those skilled in the art by reference to the following drawings, in conjunction with the accompanying specification, in which:

FIG. 1 is a block diagram illustrating a computer system that implements a preferred embodiment of the present invention;

FIG. 2 is a diagram illustrating an example of nested square, triangles, and star objects that can be selected in accordance with the teachings of the present invention;

FIG. 3 is a diagram illustrating the example of FIG. 2 with the user employing a cursor for the selection of one of the objects in accordance with the teachings of the present invention;

FIG. 4 is a flow chart illustrating the method of the present invention for selecting an object nested with a group of objects according to the teachings of a preferred embodiment of the present invention;

FIG. 5 is a diagram illustrating a cursor and a directed path, shown as a tail swirl, for selecting an object from the group of nested objects of FIG. 2 according to the teachings of a preferred embodiment of the present invention; and

FIG. 6 is a diagram illustrating a directed path for selecting an object from the objects 204-208 of FIG. 3 according to the teachings of the preferred embodiment of the present invention.

### DETAILED DESCRIPTION OF THE PREFERRED EMBODIMENT OF THE PRESENT INVENTION

The present invention is a method, system, and computer program product for assisting the user of an application with the ability to select an object nested with other objects (i.e. at least two objects within a close proximity of each other, including, but not limited to, being in contact with or overlapping each other). Upon the determination by the user that an initial attempt to select the desired object was unsuccessful, the user will indicate the incorrect selection (e.g. clicking the mouse). The present invention selects another one of the nested objects using a directed path.

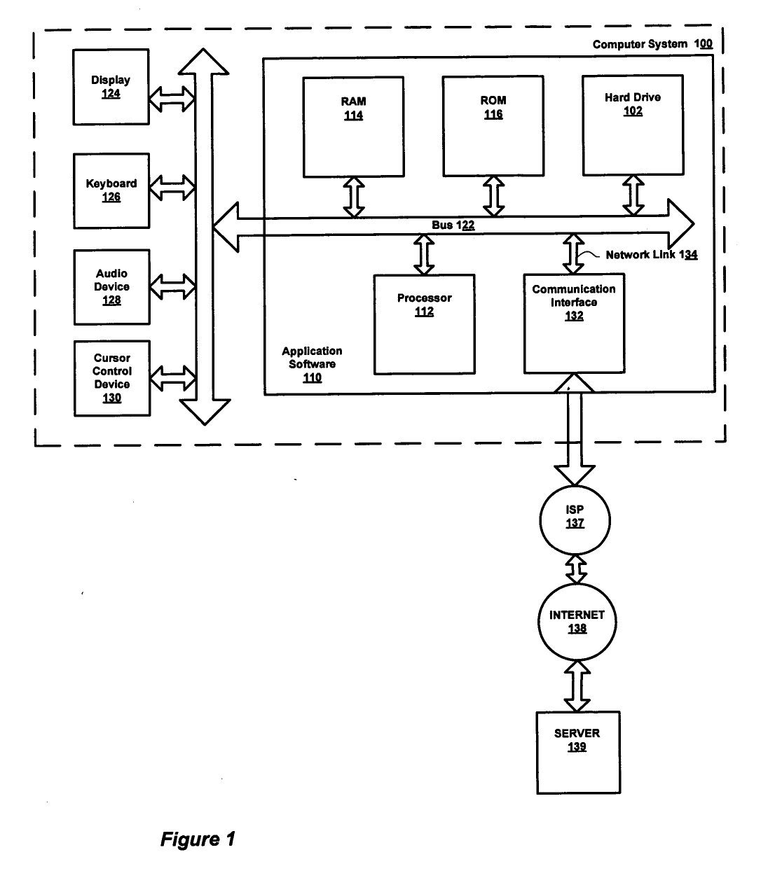

Reference now being made to FIG. 1, a block diagram is shown illustrating a computer system 100 that implements a preferred embodiment of the present invention. Computer System 100 includes various components each of which are explained in greater detail below.

Bus 122 represents any type of device capable of providing communication of information within Computer System 100 (e.g., System bus, PCI bus, cross-bar switch, etc.)

Processor 112 can be a general-purpose processor (e.g., the PowerPC™ manufactured by IBM or the Pentium™ manufactured by Intel) that, during normal operation, processes data under the control of an operating system and application software 110 stored in a dynamic storage device such as Random Access Memory (RAM) 114 and a static storage device such as Read Only Memory (ROM) 116. The operating system preferably provides a graphical user interface (GUI) to the user.

The present invention, including the alternative preferred embodiments, can be provided as a computer program product, included on a machine-readable medium having stored on it machine executable instructions used to program computer system 100 to perform a process according to the teachings of the present invention.

The term “machine-readable medium” as used in the specification includes any medium that participates in providing instructions to processor 112 or other components of computer system 100 for execution. Such a medium can take many forms including, but not limited to, non-volatile media, and transmission media. Common forms of non-volatile media include, for example, a floppy disk, a flexible disk, a hard disk, magnetic tape, or any other magnetic medium, a Compact Disk ROM (CD-ROM), a Digital Video Disk-ROM (DVD-ROM) or any other optical medium whether static or rewriteable (e.g., CDRW and DVD RW), punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the preferred embodiment, an example of a non-volatile medium is the Hard Drive 102.

Volatile media includes dynamic memory such as RAM 114. Transmission media includes coaxial cables, copper wire or fiber optics, including the wires that comprise the bus 122. Transmission media can also take the form of acoustic or light waves, such as those generated during radio wave or infrared data communications.

Moreover, the present invention can be downloaded as a computer program product where the program instructions can be transferred from a remote computer such as server 139 to requesting computer system 100 by way of data signals embodied in a carrier wave or other propagation medium via network link 134 (e.g., a modem or network connection) to a communications interface 132 coupled to bus 122.

Communications interface 132 provides a two-way data communications coupling to network link 134 that can be connected, for example, to a Local Area Network (LAN), Wide Area Network (WAN), or as shown, directly to an Internet Service Provider (ISP) 137. In particular, network link 134 may provide wired and/or wireless network communications to one or more networks.

ISP 137 in turn provides data communication services through the Internet 138 or other network. Internet 138 may refer to the worldwide collection of networks and gateways that use a particular protocol, such as Transmission Control Protocol (TCP) and Internet Protocol (IP), to communicate with one another. ISP 137 and Internet 138 both use electrical, electromagnetic, or optical signals that carry digital or analog data streams. The signals through the various networks and the signals on network link 134 and through communication interface 132, which carry the digital or analog data to and from computer system 100, are exemplary forms of carrier waves transporting the information.

In addition, multiple peripheral components can be added to computer system 100. For example, audio device 128 is attached to bus 122 for controlling audio output. A display 124 is also attached to bus 122 for providing visual, tactile or other graphical representation formats. Display 124 can include both non-transparent surfaces, such as monitors, and transparent surfaces, such as headset sunglasses or vehicle windshield displays.

A keyboard 126 and cursor control device 130, such as mouse, trackball, or cursor direction keys, are coupled to bus 122 as interfaces for user inputs to computer system 100.

The execution of application software 110 on computer system 100 according to a preferred embodiment of the present invention is explained in greater detail below.

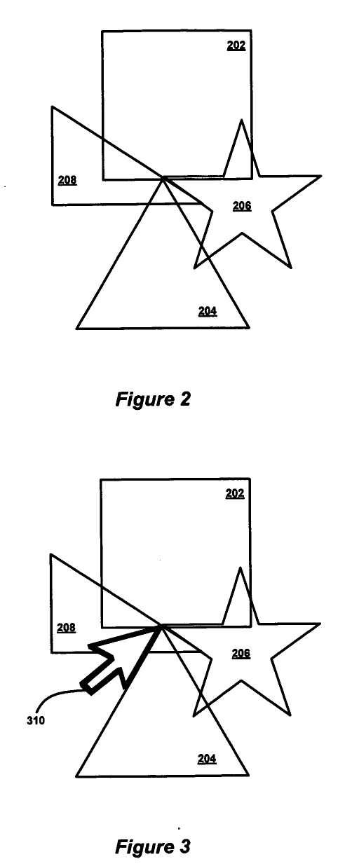

Reference now being made to FIG. 2, a diagram is shown illustrating an example of nested square 202, triangles 204 and 208, and star 206 objects that can be selected in accordance with the teachings of the present invention. It should be noted that the objects 202-208 illustrated in FIG. 2 are for ease of explanation and are not to be considered a limitation on the types or number of objects to which the present invention is applicable. For purposes of explanation, it can be assumed that a typical application such as a drawing application is being used to illustrate the objects 202-208. The objects 202-208 are illustrated at a magnification level that will cause the drawing application to have difficulty in determining which one of the objects 202-208 the user is attempting to select when using a cursor.

Reference now being made to FIG. 3, a diagram is shown illustrating the example of FIG. 2 with the user employing a cursor 310 for the selection of one of the objects 202-208 in accordance with the teachings of the present invention. The selection of the objects 202-208 is accomplished using the cursor control device 130 (FIG. 1) which can be, for example, a mouse having a cursor 310 (represented as an arrow).

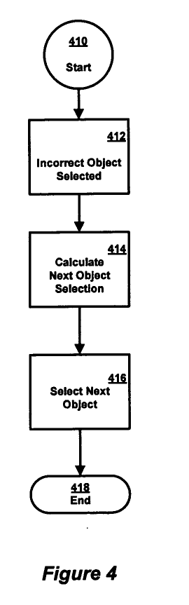

In this example, it can be assumed that the user is trying to select square object 202. As a result of the current magnification level and the nesting of the objects 202-208, the cursor 310 can simultaneously rest on two or more of the objects 202-208. Consequently, when the user indicates their selection of the object 202-208 (e.g. clicking of the mouse) the drawing application will select the triangle 208. The present invention allows the user to select another object without any movement of the cursor 210 as explained in connection with FIG. 4 below.

Reference now being made to FIG. 4, a flow chart is shown illustrating the method of the present invention for selecting an object nested with a group of objects according to the teachings of a preferred embodiment of the present invention. The method of the present invention is explained in connection with the example of FIG. 3.

The method begins upon the selection of an object (in this case triangle 208) that is nested with a group of objects (202-208) (Step 410). The determination of whether objects are nested closely together enough to invoke the method of the present invention is designer specific but can be based upon such factors as magnification level, number of objects, cursor size, and whether the cursor resides on multiple objects.

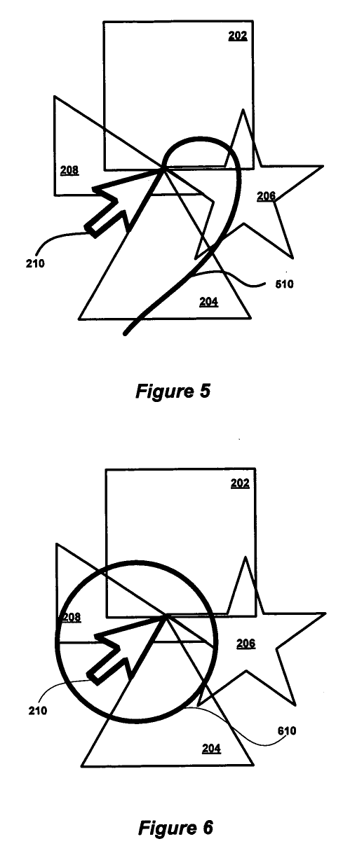

In the present example (FIG. 3), the cursor 310 resides on the square 202, triangle 208, triangle 204, and star 206 the user has indicated their desire to select an object (in this case the desire was to select square 202), and the drawing application has selected triangle 208. The user then indicates to the drawing application that the incorrect object was selected (Step 412). The particular method or technique for indicating that an incorrect object was selected is a designer choice, but can be for example, shift key, function key or any other means for providing such information. The preferred embodiment of the present invention uses the fact that the user has clicked the mouse button again without moving the mouse from the original location (Step 412). The drawing application proceeds to calculate the next object located on a designated path as explained in greater detail in connection with FIG. 5 below.

Reference now being made to FIG. 5, a diagram is shown illustrating a cursor 210 and a directed path, shown as a tail swirl 410, for selecting an object from the group of nested objects 204-208 of FIG. 2 according to the teachings of a preferred embodiment of the present invention. In the preferred embodiment of the present invention, a directed path from the cursor 210 is used for determining the next object to select from the group of objects 204-208.

Continuing with the example of FIG. 3, upon the clicking of the mouse the drawing application follows the directed path indicated by tail swirl 410 in a predetermined direction (e.g. forwards, backwards, clockwise, counterclockwise) from the current selected object (triangle 208) until a different object (triangle 206) is encountered. In the present example, the next object on the directed path of the tail swirl 410 is square 202.

It should be noted that the present invention is not limited to any particular type of directed path or direction for determining the next object. In example, the directed path can take various shapes such as square, triangle, elongated, and user defined shape. An example of using a circle is described in connection with FIG. 6 below.

FIG. 6 is a diagram illustrating a directed path 610 for selecting an object from the objects 204-208 of FIG. 3 according to the teachings of the preferred embodiment of the present invention. In the present example, the directed path is a circle 610. Referring again to the example of FIG. 3, upon the clicking of the mouse 130 the method continues from a predetermined point of the directed path 610 (e.g. the intersection of the tip of the arrow with the circle 610) in a predetermined direction until the next object 204-208 is encountered. In the present example, it can be assumed that the starting point coincides with the portion of the circle 610 that would be intersected with the tip of the cursor 310. Using this starting point, the next object would be square 202.

Referring back to FIG. 3 and the related example, upon the determination of the next object 204-208, the next object is selected (Step 316) and the method ends (Step 318).

It is thus believed that the operation and construction of the present invention will be apparent from the foregoing description. While the method, system, and computer program product shown and described has been characterized as being preferred, it will be readily apparent that various changes and/or modifications could be made without departing from the spirit and scope of the present invention as defined in the following claims.

What is claimed is:

1. A computer implemented method of selecting an object, the method comprising the steps of:
in response to receiving a selection signal from a selection means indicating a selection position in close proximity to a plurality of objects, indicating a selection of a first one of the plurality of objects; and
in response to subsequently receiving a subsequent selection signal from the selection means having the same selection position, indicating a selection of a different one of the plurality of objects.

2. The computer implemented method of claim 1 further comprising:
defining a path separately intersecting each one of the plurality of objects wherein a sequence of indicating a selection for different ones of the plurality of objects in response to a sequence of subsequently receiving subsequent selection signals is determined by the sequence of the objects along the path.

3. The computer implemented method of claim 1 wherein indicating a selection comprises highlighting the object.

4. The method of claim 3 wherein the selection signal is generated from the selection position of a cursor.

5. The method of claim 4 wherein the path is determined with reference to the position of the cursor.

6. A computer for selecting an object, the computer comprising:
means for, in response to receiving a selection signal from a selection means indicating a selection position in close proximity to a plurality of objects, indicating a selection of a first one of the plurality of objects; and
means for, in response to subsequently receiving a subsequent selection signal from the selection means having the same selection position, indicating a selection of a different one of the plurality of objects.

7. The computer of claim 6 further comprising:
means for defining a path separately intersecting each one of the plurality of objects wherein a sequence of indicating a selection for different ones of the plurality of objects in response to a sequence of subsequently receiving subsequent selection signals is determined by the sequence of the objects along the path.

8. The computer of claim 6 wherein indicating a selection comprises highlighting the object.

9. The computer of claim 8 wherein the selection signal is generated from the selection position of a cursor.

10. The computer of claim 9 wherein the path is determined with reference to the position of the cursor.

11. A computer program product comprising a computer usable medium having computer usable program code for selecting an object, the computer program product including:
computer usable program code for, in response to receiving a selection signal from a selection means indicating a selection position in close proximity to a plurality of objects, indicating a selection of a first one of the plurality of objects; and
computer usable program code for, in response to subsequently receiving a subsequent selection signal from the selection means having the same selection position, indicating a selection of a different one of the plurality of objects.

12. The computer program product of claim 11 wherein the computer usable program code further comprises:
computer usable program code for defining a path separately intersecting each one of the plurality of objects wherein a sequence of indicating a selection for different ones of the plurality of objects in response to a sequence of subsequently receiving subsequent selection signals is determined by the sequence of the objects along the path.

13. The computer program product of claim 11 wherein indicating a selection comprises highlighting the object.

14. The computer program product of claim 13 wherein the selection signal is generated from the selection position of a cursor.

15. The computer program product of claim 14 wherein the path is determined with reference to the position of the cursor.
